(19) United States
(12) Patent Application Publication
(10) Pub. No.: US 2020/0151880 A1
(43) Pub. Date: May 14, 2020

(54) RECONSTRUCTION OF DIFFERENCE IMAGES USING PRIOR STRUCTURAL INFORMATION

(71) Applicant: The Johns Hopkins University, Baltimore, MD (US)

(72) Inventors: Joseph Webster STAYMAN, Baltimore, MD (US); Amir POURMORTEZA, Atlanta, GA (US); Jeffrey H. SIEWERDSEN, Baltimore, MD (US)

(73) Assignee: The Johns Hopkins University, Baltimore, MD (US)

(21) Appl. No.: 16/617,240

(22) PCT Filed: Jun. 1, 2018
(86) PCT No.: PCT/US2018/035678

§ 371 Date: Nov. 26, 2019

Related U.S. Application Data
(60) Provisional application No. 62/514,262, filed on Jun. 2, 2017.
(60) Provisional application No. 62/514,252, filed on Jun. 2, 2017.

(51) Int. Cl. G06T 7/00; G06T 5/50; G06T 3/00

(52) U.S. Cl. CPC G06T 7/0016; G06T 5/50; G06T 3/0068; G06T 2207/10081; G06T 2207/30101; G06T 2207/30048; G06T 2207/20224

(57) ABSTRACT

A device receives a prior image associated with an anatomy of interest, and receives measurements associated with the anatomy of interest. The device processes the prior image and the measurements, with a reconstruction of difference technique, to generate a difference image associated with the anatomy of interest, wherein the difference image indicates one or more differences between the prior image and the measurements. The device generates, based on the difference image and the prior image, a final image associated with the anatomy of interest, and provides, for display, the final image associated with the anatomy of interest.

### BACKGROUND

Many diagnostic imaging studies, such as myocardial function analysis, lung nodule surveillance, and image-guided therapy tasks (e.g., image-guided surgeries and radiotherapy) involve acquiring a sequence of computed tomography (CT) images over time. However, in many cases, image information from previous studies is ignored, and images of a current anatomical state are estimated based on a latest set of measurements. Acquiring CT images at as low as reasonably achievable radiation doses has significantly reduced average radiation exposure in the past decade. Some image-based reconstruction methods attempt to leverage patient-specific anatomical information, found in prior imaging studies, to improve image quality or reduce radiation exposure. For example, prior image constrained compressed sensing (PICCS) and PICCS with statistical weightings utilize a linearized forward model and a concept that sparse signals can be recovered via an optimization strategy. Prior image registration penalized likelihood estimation (PIRPLE) utilizes patient-specific prior images in a joint registration-reconstruction objective function that includes a statistical data fit term with a nonlinear forward model, and a generalized regularization term to encourage sparse differences from a simultaneously registered prior image. Other prior image methods include prior-based artifact correction, the use of prior images for patch-based regularization, and/or the like. These methods have improved a trade-off between radiation dose and image quality in the reconstruction of the current anatomy.

### SUMMARY

According to some implementations, a device may include one or more memories, and one or more processors, communicatively coupled to the one or more memories, to receive a prior image associated with an anatomy of interest, and receive measurements associated with the anatomy of interest. The one or more processors may process the prior image and the measurements, with a reconstruction of difference technique, to generate a difference image associated with the anatomy of interest, wherein the difference image may indicate one or more differences between the prior image and the measurements. The one or more processors may generate, based on the difference image and the prior image, a final image associated with the anatomy of interest, and may provide, for display, the final image associated with the anatomy of interest.

According to some implementations, a method may include receiving a prior image associated with an anatomy of interest, and receiving measurements associated with the anatomy of interest. The method may include processing the prior image and the measurements, with a reconstruction of difference technique, to generate a difference image associated with the anatomy of interest. The difference image may indicate one or more differences between the prior image and the measurements, and the reconstruction of difference technique may provide control over image properties associated with the difference image. The method may include providing, by the device and for display, the difference image associated with the anatomy of interest.

According to some implementations, a non-transitory computer-readable medium may store instructions that include one or more instructions that, when executed by one or more processors, cause the one or more processors to receive a prior image associated with an anatomy of interest, and receive measurements associated with the anatomy of interest. The one or more instructions may cause the one or more processors to process the prior image, with a two-dimensional-to-three-dimensional registration, to generate a transformed prior image, and process the transformed prior image and the measurements, with a reconstruction of difference technique, to generate a difference image associated with the anatomy of interest. The one or more instructions may cause the one or more processors to generate, based on the difference image and the transformed prior image, a final image associated with the anatomy of interest, and provide, for display, the final image associated with the anatomy of interest.

### BRIEF DESCRIPTION OF THE DRAWINGS

FIG. 1 is a diagram of an example implementation described herein.

FIG. 2 is a diagram of an example environment in which systems and/or methods, described herein, may be implemented.

FIG. 3 is a diagram of example components of one or more devices of FIG. 2.

FIG. 4A is a diagram of an example graphical view of a root-mean-square error (RMSE), relative to truth and as a function of regularization parameters, that may be utilized with systems and/or methods described herein.

FIG. 4B is a diagram of an example graphical view of zoomed region of interest (ROI) difference images that may be generated with systems and/or methods described herein.

FIGS. 5A-5C are diagrams of example results that may be generated with systems and/or methods described herein.

FIG. 6A is a diagram of an example graphical view of incident fluence in a reconstruction of difference method, that may be generated with systems and/or methods described herein, as compared to a penalized likelihood method.

FIGS. 6B and 6C are diagrams of example image views of performance of the reconstruction of difference method as compared to the penalized likelihood method.

FIGS. 7A-7C are diagrams of example trends in performance of the penalized likelihood method and the reconstruction of difference method, at different levels of data sparsity.

FIG. 8 is a diagram of example graphical views of shift and rotation variations for the reconstruction of difference method.

FIGS. 9A and 9B are diagrams of example image views of results that may be generated with systems and/or methods described herein.

FIG. 10 is a flow chart of an example process for reconstruction of difference images using prior structural information.

FIG. 11 is a flow chart of an example process for reconstruction of difference images using prior structural information.

FIG. 12 is a flow chart of an example process for reconstruction of difference images using prior structural information.

### DETAILED DESCRIPTION

The following detailed description of example implementations refers to the accompanying drawings. The same reference numbers in different drawings may identify the same or similar elements.

In many sequential imaging tasks, an ultimate goal is to characterize a difference between prior anatomy and a current anatomy. Example tasks include monitoring of a growth or a shrinkage of a tumor during or after image-guided radiotherapy (IGRT), localizing and visualizing a surgical tool, implant, or treatment during image-guided surgery (IGS), visualizing contrast agents (e.g., in perfusion CT and digital subtraction angiography studies or in monitoring results of spinal or dental surgeries), and/or the like. One method that attempts direct reconstruction of difference (RoD) includes utilizing penalized likelihood (PL) estimation to reconstruct projections formed from a difference between prior and current CT projections. Unfortunately, this method presumes that subtraction of noisy projections is Poisson and introduces additional complexity when projection differences between the noisy projections are negative.

Some implementations, described herein, may provide a system for reconstruction of difference images using prior structural information. For example, the system may receive image data, and receive measurements of an anatomy of interest. The system may process the image data and the measurements of the anatomy of interest using a reconstruction of difference method or technique, and may generate a reconstructed image of the anatomy of interest. The system may integrate the image data in a data consistency term, and may utilize a measurement forward model. The system may apply the reconstruction of difference method to cardiac imaging, vascular imaging, angiography, neurovascular imaging, neuro-angiography, image-guided surgery, image-guided radiation therapy, spectral or photon-counting CT, and/or the like. The system may limit the field of view of data acquisitions to a region of interest, and thereby may reduce a total radiation dose.

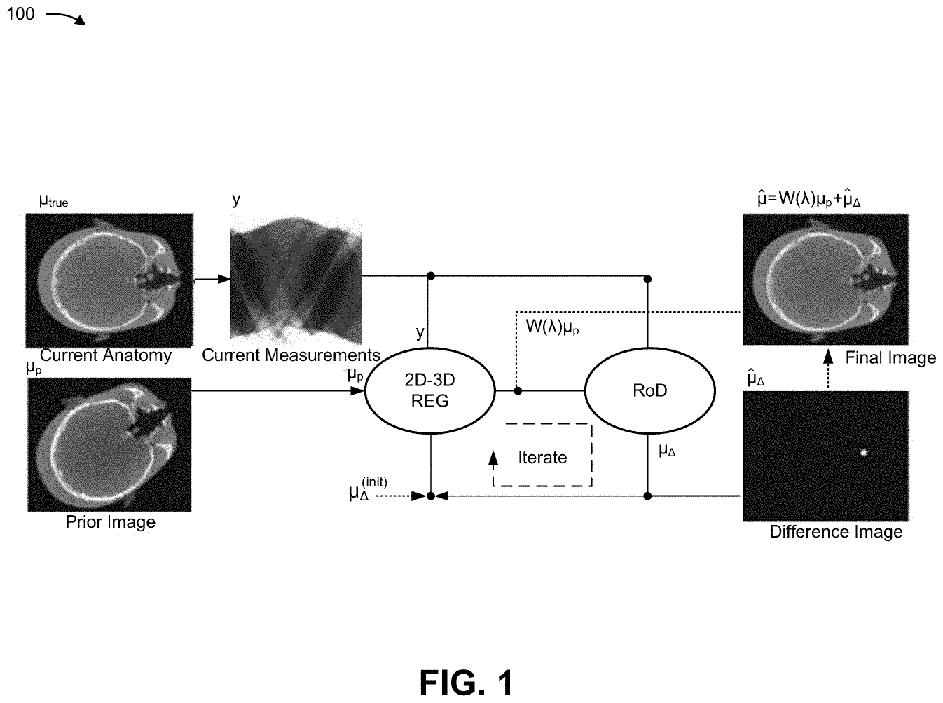

FIG. 1 is a diagram of an example implementation 100 described herein. In some implementations, FIG. 1 may provide a flowchart for a reconstruction of difference (RoD) method or technique. In some implementations, the reconstruction of difference method may presume that a previously acquired image volume (μₚ) is available to serve as a prior image. Alternatively, previously acquired projection data (yₚ) may be used. A subsequent acquisition of tomographic projection data (y) may be available, and a current anatomy may share similarities with the prior image. In some implementations (e.g., spectral photon-counting CT), a current anatomy may include one energy bin data, whereas a prior anatomy may include entire detected photon counts regardless of energies. In some implementations, the current anatomy and the prior image may not be registered, and a two-dimensional-to-three-dimensional registration may be conducted to form a transformed prior image (W(λ)μₚ), where a registration operator (W) may be parameterized by a vector (λ). As opposed to traditional reconstruction methods that attempt to reconstruct a true current anatomy (μₜᵣᵤₑ) from the tomographic projection data (y), reconstruction of difference method may reconstruct a difference image (μΔ) between the image of the current anatomy and the prior image. For example, as shown in FIG. 1, a RoD estimator may receive the tomographic projection data (y) and the transformed prior image (W(λ)μₚ), and may generate an estimate of the difference image (μΔ) based on the tomographic projection data and the transformed prior image. In some implementations, the difference image (μΔ) and the prior image (μₚ) may be utilized to compute a final image (μ). In some implementations, the two-dimensional-to-three-dimensional registration and the RoD estimation may be iterated to refine a calculation of the difference image (μΔ). In some implementations, the registration may include three-dimensional-to-three-dimensional registration, two-dimensional-to-two-dimensional registration, another registration technique, and/or the like.

In some implementations, a model for mean measurements of a transmission tomography system may be utilized and include:

yᵢ=bᵢ·exp(−[Aμ]ᵢ), (1)

where bᵢ may include a gain term associated with a number of unattenuated photons (e.g., x-ray fluence) and detector sensitivities, μ may include a vector of attenuation coefficients representing the current anatomy, A may include system matrix, [Aμ]ᵢ may include a line integral associated with the ith measurement, and yᵢ may be independent and Poisson distributed.

In some implementations, a current image volume may be modeled as a sum of a registered prior image (μₚ) and a difference image (μΔ) as follows:

μ=W(λ)μₚ+μΔ, (2)

where W may include a general transformation operator with parameter λ and may represent a deformable registration. In some implementations, W may be parameterized as a rigid transform. In some implementations, measurements from Equation (1) may be rewritten in a vector form as follows:

y=b·exp(−AW(λ)μₚ)·exp(−Aμ_{Δ}), (3)

where an operator (·) may indicate an element-by-element vector multiplication.

In some implementations, a first two terms of Equation (3) may be combined into a single gain parameter (g) as follows:

y=g(λ)·exp(−Aμ_{Δ}). (4)

Equation (4) may reduce a difference forward model to a same form as a traditional forward model of Equation (1). Equation (4) may permit use of standard reconstruction models with only a redefinition of a gain term. In some implementations, a factorization in Equation (1) may separate a dependence of λ on μΔ, and may indicate that registration may be decoupled from the reconstruction.

In some implementations, the following PL objective function may be utilized for reconstruction of the difference image:

Φ(μ_{Δ},λ;y,μₚ)=−L(μ_{Δ},λ;y,μₚ)+β_{R}∥Ψμ_{Δ}∥l+β_{M}∥μ_{Δ}∥l, (5)

with an implicitly defined estimator:

{μ\hat{ },λ\hat{ }}=argmin μ_{Δ},λΦ(μ_{Δ},λ;y,μₚ), (6)

where a Poisson log-likelihood function may be denoted with L. In some implementations, the PL objective function may utilize two regularization terms leveraging sparsity in multiple domains, similar to work that regularizes in multiple domains. A second term in Equation (5) may include a traditional edge-preserving roughness penalty term that encourages smooth solutions and with a strength that is controlled by a scalar regularization parameter (β_{R}). In some implementations, Ψ may be selected as a local pairwise voxel difference operator for a first-order neighborhood. To ensure a differentiable objective, an l1 norm may be approximated using a Huber penalty function with a small δ parameter. The parameter (δ) may control a location of a transition between quadratic and linear portions of the Huber function. In some implementations, a parameter of a particular value (e.g., δ=10⁻⁴ mm⁻¹) may be utilized for all reconstructions. A third term in Equation (5) may include a magnitude penalty on μΔ with strength β_{M} that encourages the difference image to be sparse (e.g., a change in anatomy may be local and relatively small).

While the roughness penalty may be intuitive in controlling the noise-resolution tradeoff, a function of the magnitude penalty may be more complex. The magnitude penalty may control an amount of prior image information used in image formation. A large β_{M} may force the difference image to be closer to zero, and may enforce smaller allowable differences from the prior image. A small β_{M} may permit larger differences from the prior image and therefore a greater reliance on the current projection data. However, the increased reliance on the current projection data may lead to attenuation differences due to noise. In some implementations, a proper balance and control of prior information inclusion may be selected, and is discussed below.

In some implementations, the optimization in Equation (6) may be solved using a two-step alternating approach to jointly solve for λ\hat{ } and μ\hat{ }. In such implementations, the registration parameters λ may be updated using a traditional gradient-based approach with a fixed attenuation estimate, and the difference image μΔ may be estimated iteratively using a tomography-specific image update with fixed registration. In some implementations, the registration step may be determined as follows:

λ^{[n]}=argmin λ∈R6Φ(λ;y,μₚ,μ^{[n-1]}Δ)=argmin λ∈R6{−L(λ;y,μₚ,μ^{[n-1]}}). (7)

In some implementations, Equation (7) may represent a two-dimensional-to-three-dimensional likelihood-based rigid registration approach. In such implementations, the W operator in Equation (2) may be parameterized using B-spline kernels to ensure differentiability. This may allow for use of a quasi-Newton update method using Broyden-Fletcher-Goldfarb-Shanno (BFGS) updates to optimize the objective function in Equation (7). In some implementations, function and gradient evaluations may be straightforward to compute and may be derived from Equation (5) by eliminating factors dependent only on attenuation (e.g., including the regularization terms). The bracketed superscript ([n]) may denote an nth estimate of the parameter vector, and may formalize that an nth alternation of registration updates depends on a previous, (n−1)th alternation of image updates.

In some implementations, for image volume updates, the optimization part may be determined as:

μ^{[n]}Δ=argminμ_{Δ}∈RNμΦ(μ_{Δ};y,μₚ,λ^{[n]})=argminμ_{Δ}∈RNμ{−L(μ_{Δ};y,μₚ,λ^{[n]})+β_{R}∥Ψμ_{Δ}∥1+β_{M}∥μ_{Δ}∥∥1}, (8)

which may include a transformed prior image with a fixed λ from a previous set of registration updates. The roughness and magnitude penalty terms may satisfy criteria for finding paraboloidal surrogates. Therefore, a separable paraboloidal surrogates (SPS) approach with ordered-subsets subiterations for improved convergence rates may be utilized. The difference image pi may represent a change in attenuation coefficients between scans and may include positive or negative values. Consequently, traditional non-negativity constraints on the reconstruction may not be applied. The SPS image update equation may be derived as follows:

[μ^{[n+1]}Δ]ⱼ=[μ^{[n]}Δ]ⱼ+ΣNᵢ=1A_{ijh,i}([Aμ^{[n]}Δ]ᵢ)−β_{R}Σkₖ=1Ψkjf.([Ψμ^{[n]}Δ]ₖ)−β_{M}ΣKₖ=1f.([μ^{[n]}Δ]ₖ)ΣNᵢ=1A2jiCi([Aμ^{[n]}Δ]ᵢ)+β_{R}ΣKₖ=1Ψ2kjω([Φμ^{[n]}Δ]ₖ)+β_{M}ΣKₖ=1ω([μ^{[n]}Δ]ₖ), (9)

where Ci may include optimal curvatures, and t. may include a derivative of the Huber penalty function and ω(t)=f(t.)/t. Derivatives of marginal log-likelihoods may be defined as h.i(l)=gie−li−yi with gi=bie[−AW(λ[n])μp]i.

In some implementations, Table 1 depicts pseudocode for an alternating joint registration and image update approach (e.g., the reconstruction of difference method). An outer loop may iterate over registration and image updates, where each update includes inner loops over BFGS and ordered subsets iterations, respectively.

```
TABLE 1 [symbol]
= Initial guess for difference image (zero or difference between FBPs) [symbol]
= Initial guess for registration parameters [symbol]
= σ [symbol] , Initial guess for inverse Hessian
FOR n = 0 to [symbol]
  % registration update block
  FOR r = 1 to R
    Compute [symbol] [symbol]
    = BFGS update based on [symbol] , [symbol]
    \hat{γ} = line search in [symbol]  + [symbol] [symbol]
      = [symbol]  + [symbol]
  END [symbol]
  = [symbol] ; [symbol]  = [symbol]
  % image update block
  FOR m = 1 to M (number of ordered subsets)
    & = [symbol] [symbol]   , [symbol]  = [symbol] [symbol]    = [symbol]  ∀ [symbol]   ∈ [symbol]
    FOR j = 1 to [symbol]
    $\text{?} = \text{?} + \frac{M \text{?} \text{?} - {β}_{R} \text{?} \text{?} f ( [ \text{?} ] \text{?} ) - {β}_{M} \text{?} f ( [ \text{?} ] \text{?} )}{M \text{?} \text{?} + {β}_{R} \text{?} \text{?} ω ( [ \text{?} ] \text{?} ) + {β}_{M} \text{?} ω ( [ \text{?} ] \text{?} )}$
    END
  END
END [symbol]
indicates data missing or illegible when filed
```

In some implementations, the simultaneous image update in Equation (9) may be parallelized for efficient computation on a graphical processing unit (GPU). In some implementations, routines may include calls to custom external libraries for separable-footprint projectors and back-projectors in C/C++ using CUDA libraries for execution on a GPU.

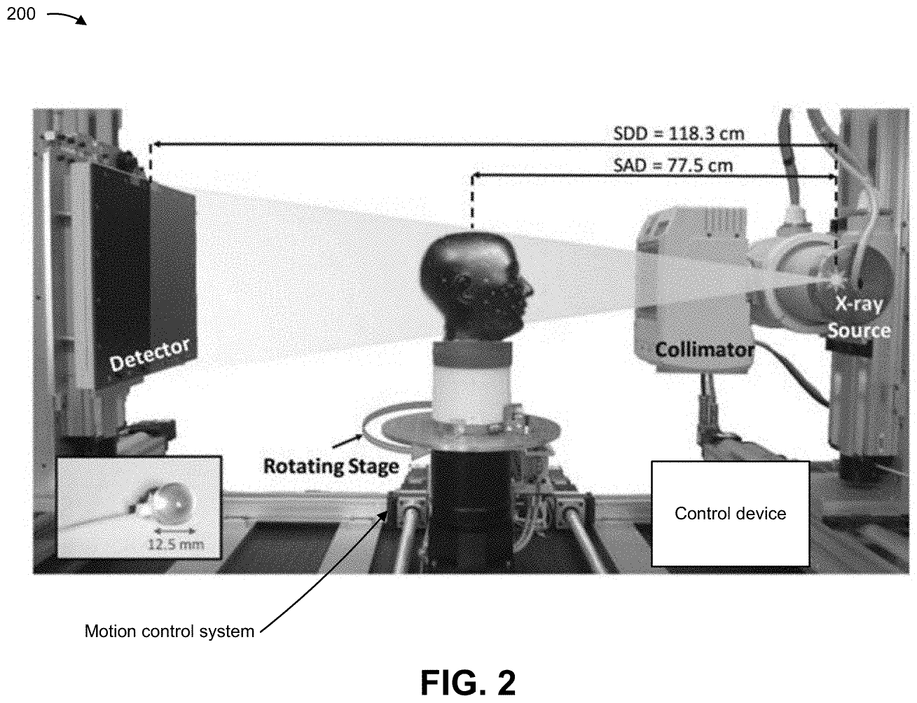

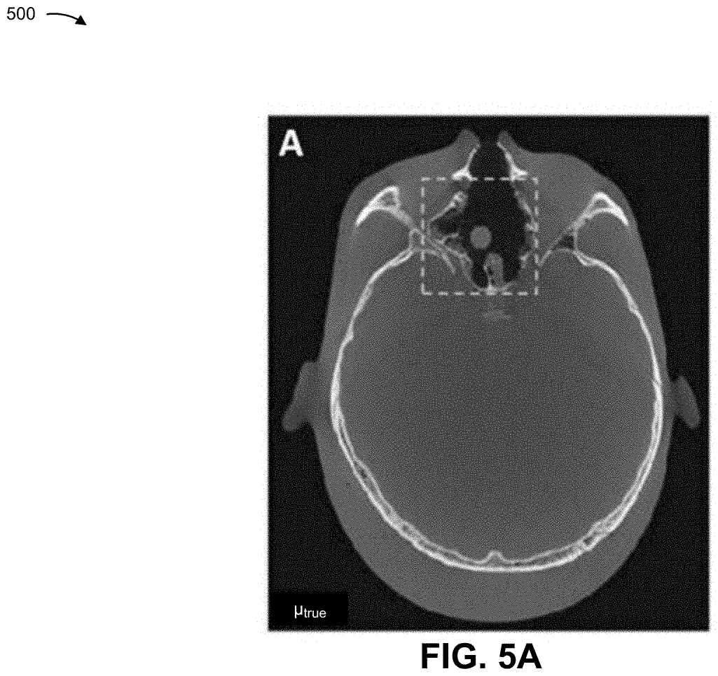

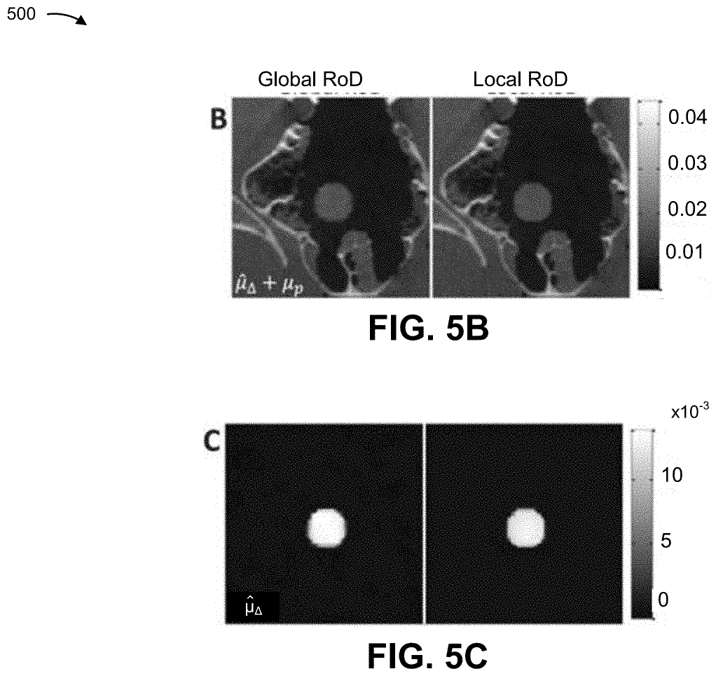

In some implementations, growth of a spherical lesion in a nasal cavity of an anthropomorphic head phantom may be simulated with systems and/or methods described herein. For example, a digital phantom image may be formed from low-noise cone-beam CT (CBCT) measurements (e.g., 100 kVp, 453 mAs, 720 projections over 360°) using the example environment described below in connection with FIG. 2 and a PL reconstruction (e.g., with a 0.5 mm isotropic voxel size). The image may be utilized as a prior image (μₚ) for subsequent tests. A spherical lesion (e.g., with a 10.5 mm diameter and a 0.02 mm⁻¹ attenuation simulating a tumor, mucocele, or other abnormality to be detected) may be digitally added to the nasal cavity, as described below in connection with FIG. 5A, to create a ground truth image for the current anatomy. Simulated new measurements may be created by projecting this with lesion volume (e.g., for 720 angles over 360°). Acquisitions with different levels of x-ray fluence may be simulated by adding various levels of Poisson noise to noiseless measurements. These data sets may be utilized to investigate sensitivity to the regularization parameters, local versus global reconstruction, and performance of the RoD estimator with varying data fidelity. A separate data set may be simulated by rigid transformation of a prior image with a set of known λ to investigate a performance of the registration step on image quality. In some implementations, a root-mean-square error (RMSE) between the RoD estimate and the ground truth difference image may be used as a measure of image quality. The RMSE may be calculated over a large (e.g., 100×100 voxel) neighborhood around the spherical lesion in order to include boney structures in a background as well as air and soft tissue of the nasal cavity.

The objective function in Equation (5) may include two coefficients β_{R}, β_{M} that control a strength of the roughness and prior magnitude penalty, respectively. Optimal penalty strength trends may be examined by performing the reconstruction with an exhaustive two-dimensional sweep of coefficients for one slice of the volume. The coefficients may be varied linearly in the exponent (e.g., from 10⁰ to 10⁵ with a 10^{1/2} step size). Fluence (e.g., 104 photons) and a quantity of projections (e.g., 180) may be fixed for all reconstructions. The coefficient values that produced the smallest RMSE may be chosen as the optimal settings.

In this way, the RoD method may provide advantages over other model-based reconstruction methods. For example, if a change in anatomy is known to be local and inside a relatively small region of intertest, μ_{Δ} may be assumed to be zero everywhere else. Thus, unlike other model-based methods that require a full parameterization of the entire imaging volume or that utilize interior tomography solutions, the RoD method may be employed to reconstruct only those regions where there is anatomical change. This may significantly reduce resource (e.g., processing resources, memory resources, and/or the like) utilization for the RoD method and may increase computational times. Similarly, as long as an anatomical change is covered in the projection data, truncated acquisitions may be obtained, which may provide for dose reduction.

In some implementations, the local approach may be simulated by truncating rays that do not intersect with a region of interest (e.g., a 100×100 ROI around a lesion that simulates a dynamically collimated truncated data set) and by selecting a support (e.g., a 100×100 voxel support) for image reconstruction. For comparison, a global RoD may be performed over a full field of view (e.g., 512×512 voxels) without data truncation. The prior image used in both approaches may not be truncated. Optimal penalty coefficients may be exhaustively searched, as described above, and the RMSE may be calculated over the same region of interest (e.g., the 100×100 anatomical ROI) in the local and global approaches.

In some implementations, prior-image-based reconstruction methods may be used in many scenarios to overcome poor data fidelity, including situations involving poor signal-to-noise ratio and sparse sampling. Specifically, the effects of noise on the RoD method may be examined using measurements with simulated fluence (e.g., ranging from 10² to 10⁵ photons per pixel) swept linearly in an exponent with a step size (e.g., a 10^{1/2} step size and using 180 projections over 360°). For comparison, these measurements may be reconstructed with an ordinary PL approach (e.g., without a prior image model) with a same form of roughness penalty as used in the RoD method. The PL roughness penalty coefficient may also be swept (e.g., from 10² to 10⁵ with a 10^{1/2} step). In some implementations, a test may be performed to examine a dependence of the RoD method and the PL approach on data sparsity. In such implementations, projections (e.g., 720 projections) may be subsampled (e.g., with factors of 2, 4, 8, 16, 30, and 45) at a fixed fluence (e.g., 104 photons per pixel). A local RoD method may be utilized, as described above, and a PL reconstruction may be performed on the full field of view. Penalty coefficients may be determined through a search.

In some implementations, in order to understand sensitivity to misregistration, a registration test may be performed where a prior volume is transformed by a known amount (λₜᵣᵤₑ) and transformation parameters (λ_{Δ}) are estimated using RoD likelihood-based rigid registration. For each transformation parameter, values (e.g., 50 values) may be randomly selected from a bimodal distribution while remaining parameters may be fixed at zero. Translations (e.g., in mm) may be selected from a bimodal distribution (e.g., defined by N(−40, 15)+N(40, 15) and rotations, in degrees, selected from N(−45, 22.5)+N(45, 22.5), where N(m, s) is a Gaussian distribution with a mean m and a standard deviation s). The error in transformation parameter estimation as well as the RMSE between the estimated image and the ground truth image may be calculated. Images may be reconstructed (e.g., at a 256×256×241 matrix size with 1 mm isotropic voxels).

Capture range of a parameter may be defined as an interval within which the RMSE is within (e.g., ±0.0005 mm⁻¹) of the RMSE of the RoD image reconstructed from a perfectly pre-registered prior image. Additionally, performance of the registration model when the prior image was transformed by ten sets of λ's with nonzero elements may be tested, which may be created by a combination of single translations and rotations along all axes randomly selected within determined capture ranges.

In this way, implementations described herein may provide a RoD method to directly reconstruct an anatomical difference image from current projections and a forward model that includes a prior image. The RoD method may permit direct control and regularization of the anatomical difference image (e.g., as opposed to the current anatomy), and may provide improved control over the image properties of the difference image. Moreover, if changes are known to be local and spatially limited, the RoD method may provide local acquisition and reconstruction techniques that offer superior computational speed and dose reduction. In contrast, current model-based approaches generally require full reconstruction support even if only a small volume of interest is sought. Local acquisition dose-saving may be advantageous, especially in dynamic imaging scenarios, to reduce or eliminate unnecessary radiation exposures to regions of the body that are not of diagnostic interest for the imaging task. For example, the RoD method may be utilized with four-dimensional cardiac imaging, where a motion of the heart, which lies in a central region of a scan field of view, is of interest.

The RoD method may reconstruct a difference image directly from current measurements. The RoD method relies on prior image data, but unlike current prior image based reconstruction (PBIR) methods, the prior information is integrated in a data consistency (e.g., a measurement forward model) term. In this way, the RoD model may change a primary output of the reconstruction to be a difference image, and may relate regularization and control of image properties to a change (e.g., a difference image) as opposed to current anatomy.

Additionally, in many clinical cases including CT cardiac function, image-guided surgery (IGS), and image-guided radiation therapy (IGRT), change is limited to a relatively small volume of interest (VOI). In such cases, the RoD method may drastically reduce a support size for reconstruction, may facilitate processing resource speed, may reduce memory resource utilization, may provide truncated, limited FOV data acquisitions, which in turn reduces radiation dosage, and/or the like. In some implementations, the RoD method may be utilized for photon counting CT (PCCT). In PCCT (or other spectral imaging techniques), projections created from all photons, regardless of energies, may be used as the prior image, in order to reconstruct images of individual energy bins, which contain fewer photons and are therefore noisier. Thus, the RoD method may be utilized for PCCT since the prior image and current measurements are inherently registered.

In some implementations, the RoD method may provide control over the difference image based on utilization of penalty terms different from a roughness penalty (e.g., a high-pass filter). In such implementations, the RoD method may utilize any filter, such as a Fourier transform filter, a discrete cosine transform (DCT) filter, a wavelet filter, and/or the like.

In some implementations, the RoD method may be utilized for spectral denoising. In such implementations, prior data may be acquired simultaneously with the current measurements. The prior data may include projections acquired from all detected photons, regardless of energies, and the current measurements may include projections for one energy bin.

As indicated above, FIG. 1 is provided merely as an example. Other examples are possible and may differ from what was described with regard to FIG. 1.

FIG. 2 is a diagram of an example environment 200 in which systems and/or methods, described herein, may be implemented. As shown in FIG. 2, environment 200 may include a system that obtains CBCT measurements and performs the RoD method. The system may include an x-ray source, a collimator, a detector, a motion control system, and a control device.

The x-ray source may include a device that produces x-rays. The x-ray source may be used in a variety of applications, such as medicine, fluorescence, electronic assembly inspection, measurement of material thickness in manufacturing operations, and/or the like. In some implementations, the x-ray source may include a Rad-94 x-ray source provided by Varian Medical Systems of Palo Alto, Calif.

The collimator may include a device that narrows a beam of particles or waves. The collimator may narrow the beam by causing directions of motion to become more aligned in a specific direction (e.g., make collimated light or parallel rays) or by causing a spatial cross section of the beam to become smaller (e.g., a beam limiting device).

The detector may include a device used to measure flux, spatial distribution, spectrum, and/or other properties of x-rays. The detector may include an imaging detector (e.g., an image plate or a flat panel detector), a dose measurement device (e.g., an ionization chamber, a Geiger counter, a dosimeter, and/or the like), and/or the like. In some implementations, the detector may include a Varian PaxScan 4030CB flat-panel detector provided by Varian Medical Systems of Palo Alto, Calif.

The motion control system may include a device that provides motion to an object being radiated with the x-ray source. In some implementations, the motion control system may include a rotating stage that rotates the object. In some implementations, the motion control system may be provided by Parker Hannifin of Mayfield Heights, Ohio.

The control device includes one or more devices capable of receiving, generating, storing, processing, and/or providing information, such as information described herein. For example, the control device may include a laptop computer, a tablet computer, a desktop computer, a handheld computer, a server device, or a similar type of device. In some implementations, the control device may receive information from and/or transmit information to the x-ray source, the collimator, the detector, and/or the motion control system, and may control one or more of the x-ray source, the collimator, the detector, and/or the motion control system. In some implementations, one or more of the functions performed by the control device may be hosted in a cloud computing environment or may be partially hosted in a cloud computing environment. In some implementations, the control device may be a physical device implemented within a housing, such as a chassis. In some implementations, the control device may be a virtual device implemented by one or more computer devices of a cloud computing environment or a data center.

In some implementations, the system may simulate a C-arm system (e.g., with a 118 cm source-to-detector distance and 77.4 cm source-to-axis distance). As shown in FIG. 2, the system may hold an anthropomorphic head phantom on the rotating stage. The inset of FIG. 2 depicts an acrylic sphere that is placed in a nasal cavity of the phantom in order to mimic a tumor growth. In some implementations, the system may perform two scans (e.g., at 100 kVp and 453 mAs with 720 projections over 360°) of the phantom, with and without the acrylic sphere inserted. In some implementations, a reconstruction of the scan with no acrylic sphere may be used as a prior image, and a reconstruction of the scan with the acrylic sphere inserted may be used as a ground truth for the current anatomy.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

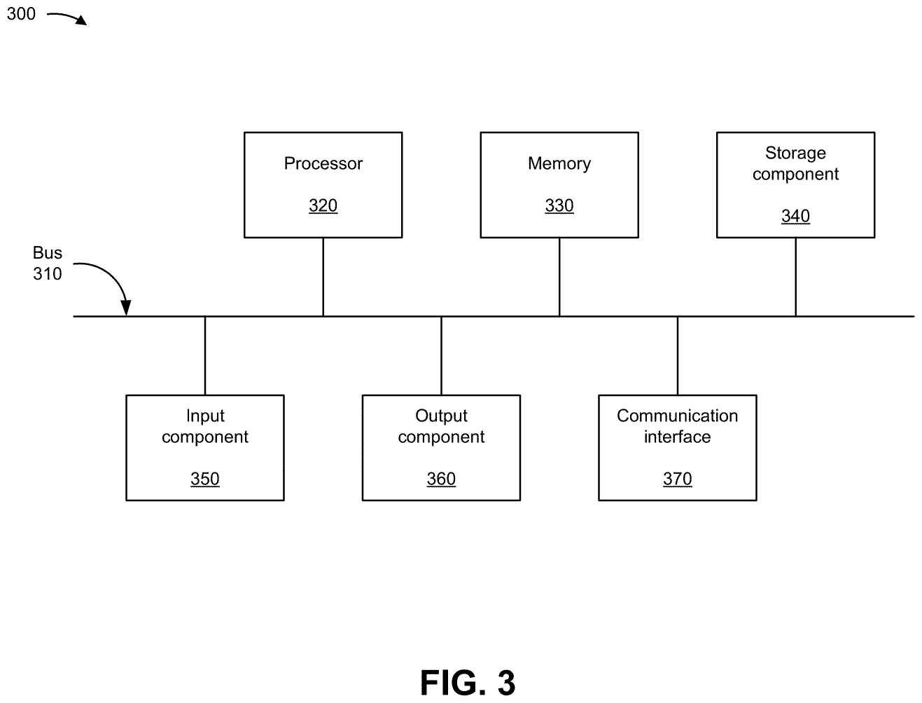

FIG. 3 is a diagram of example components of a device 300. Device 300 may correspond to the x-ray source, the collimator, the detector, the motion control system, and/or the control device. In some implementations, the x-ray source, the collimator, the detector, the motion control system, and/or the control device may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In some implementations, a performance of RoD method may be examined in reconstructing a three-dimensional volume, with an unregistered prior image. A rigid transformation matrix may be created to form a misregistered prior image. Registration parameters (e.g., λ: −4, 5, and −10 mm shifts, and 10°, −7°, and 30° rotations for x, y, and z axes respectively) may be within a capture range of translations and rotations calculated from results. Poisson noise may be added to projections of the three-dimensional volume with tumor measurements to simulate fluence (e.g., of 5000 photons) and penalty coefficients may be chosen based on results of a search of the simulated data. In such implementations, the effects of the penalty coefficients β_{R}, β_{M} on reconstructed image quality may be determined.

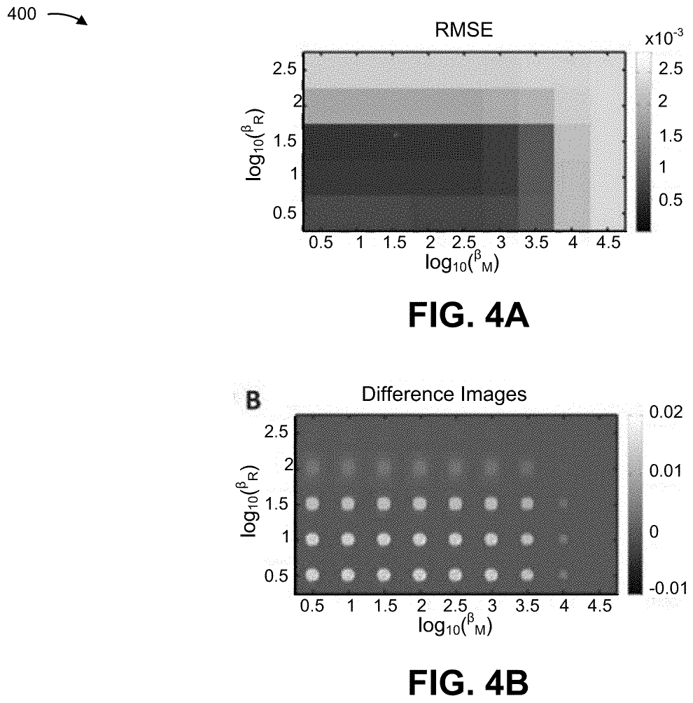

FIG. 4A is a diagram of an example graphical view of a root-mean-square error (RMSE), relative to truth and as a function of regularization parameters, that may be utilized with systems and/or methods described herein. While FIG. 4B is a diagram of an example graphical view of zoomed region of interest (ROI) difference images that may be generated with systems and/or methods described herein. As shown in FIGS. 4A and 4B, increasing β_{R} may result in less noisy difference images by forcing the reconstruction to be spatially smooth, where coefficient values larger than 10² may completely blur the difference image. Similar to the roughness penalty coefficient, large values of β_{M} may create less noisy images but by different means (e.g., a magnitude penalty forces the reconstructed image to be sparse). In some implementations, a β_{M} larger than 10^{4.5} may force the reconstructed image to be completely sparse (e.g., zero everywhere). In such implementations, β_{R}, β_{M}=10^{1.5} may produce a best image quality in terms of RMSE. An exhaustive search of the two-dimensional β_{R}, β_{M} space may be time consuming, especially in the case of large three-dimensional volume reconstructions. However, a basic trend in RMSE map suggests that the optimum point may be located by starting from low regularization levels and performing one-dimensional searches along the β_{R} axis and then along the β_{M} axis.

FIGS. 5A-5C are diagrams of example results that may be generated with systems and/or methods described herein. In some implementations, FIGS. 5A-5C may depict results of a global and local RoD test. Both a summed current anatomy volume (μₚ+μ\hat{ }_{Δ}) and a difference volume (μ\hat{ }_{Δ}) are shown for the local and global approaches. Images may be reconstructed with RMSE-optimal penalty coefficients (e.g., though omitted for brevity, penalty coefficient RMSE maps for the local and global RoD showed similar trends). In some implementations, the RMSE may include 4.02×10⁻⁴ (mm⁻¹) for the local approach and 4.19×10⁻⁴ (mm⁻¹) for the global approach. As shown in FIGS. 5A-5C, the performance of local and global RoD may be comparable, and there may be a slight improvement in RMSE when local RoD is utilized. This may be because local RoD enforces zero difference image values outside a ROI, whereas global RoD estimates voxel values outside the ROI with some potential propagation of error/noise from the outside into the ROI when RMSE is computed.

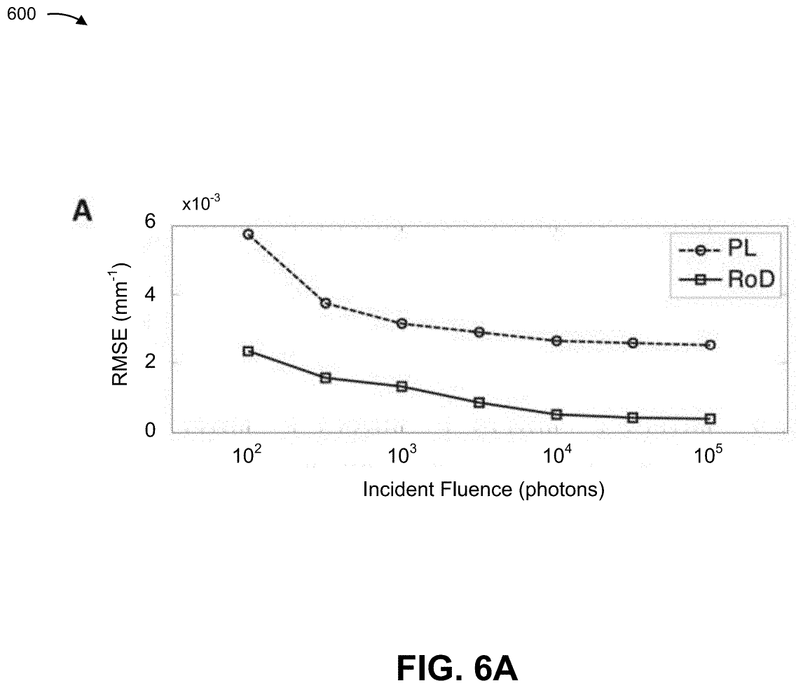

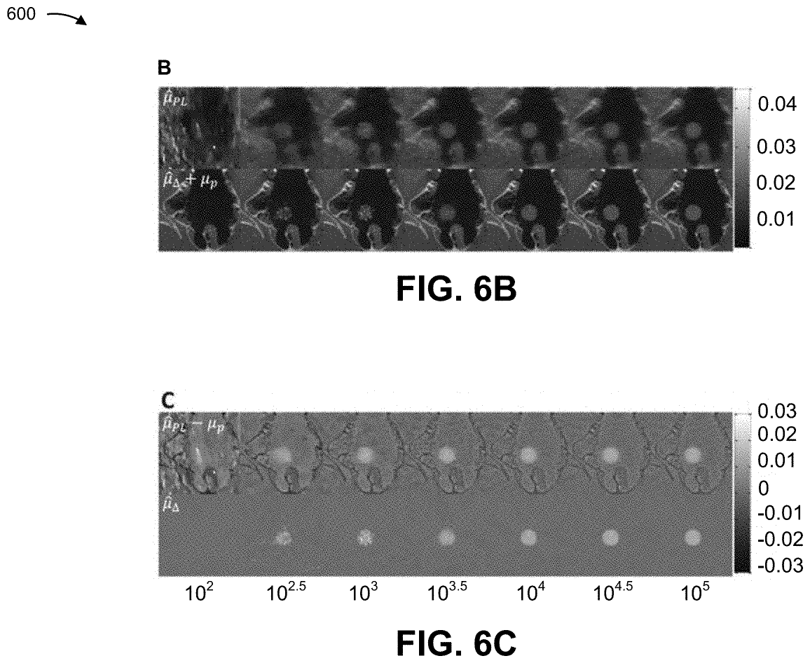

In some implementations, a performance of the RoD method under different levels of data fidelity may be tested. In such implementations, the fidelity of the measurements may be changed by simulating noisy measurements, subsampling a number of projections. Results of the performance of the RoD method, as compared to the PL method, in reconstructing measurements with decreasing photon fluence, are depicted FIGS. 6A-6C.

FIG. 6A is a diagram of an example graphical view of incident fluence in a reconstruction of difference method, that may be generated with systems and/or methods described herein, as compared to a penalized likelihood method. FIGS. 6B and 6C are diagrams of example image views of performance of the reconstruction of difference method as compared to the penalized likelihood method. The performance of both methods deteriorated as photon fluence decreased to a point that at a particular fluence (e.g., 100 photons per pixel) both methods failed to reconstruct the difference. However, the RoD method performed consistently better than the PL method. In some implementations, the anatomical change images of the PL method may be calculated by subtracting the prior image from the PL estimate, and by showing structural differences in the background.

A significant amount of anatomical structure is present in the PL method difference images (e.g., particularly due to bones near the sinus cavity), as opposed to the RoD method which does not exhibit such structure and yields an image much closer to a true anatomical difference. This performance difference may be due to the differing regularization between the prior image and the PL reconstruction, whereas the regularization in the RoD method may be adjusted to mitigate the appearance of such differences.

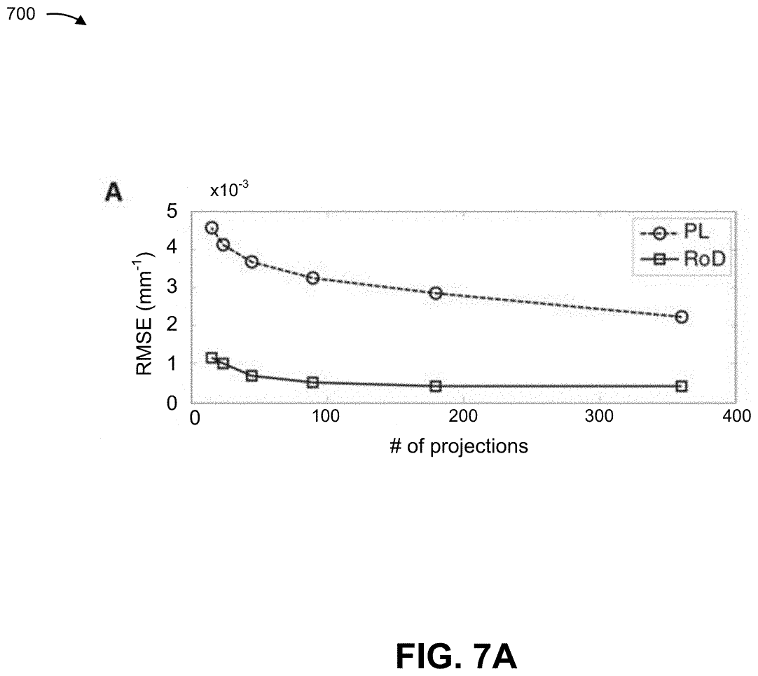

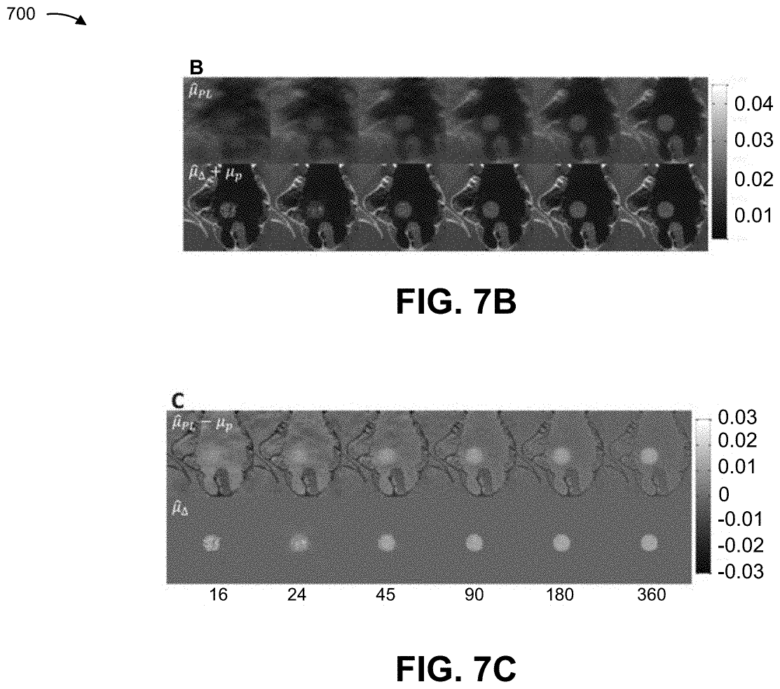

FIGS. 7A-7C are diagrams of example trends in performance of the penalized likelihood method and the reconstruction of difference method, at different levels of data sparsity. In some implementations, FIGS. 7A-7C depict a similar trend in the performance of the PL method and the RoD method at different levels of data sparsity. The structural differences may also be present in the background of subtracted PL images. Furthermore, the performance of the RoD method does not decline much compared to the PL method when a quantity of projections is reduced (e.g., from 360 to 90).

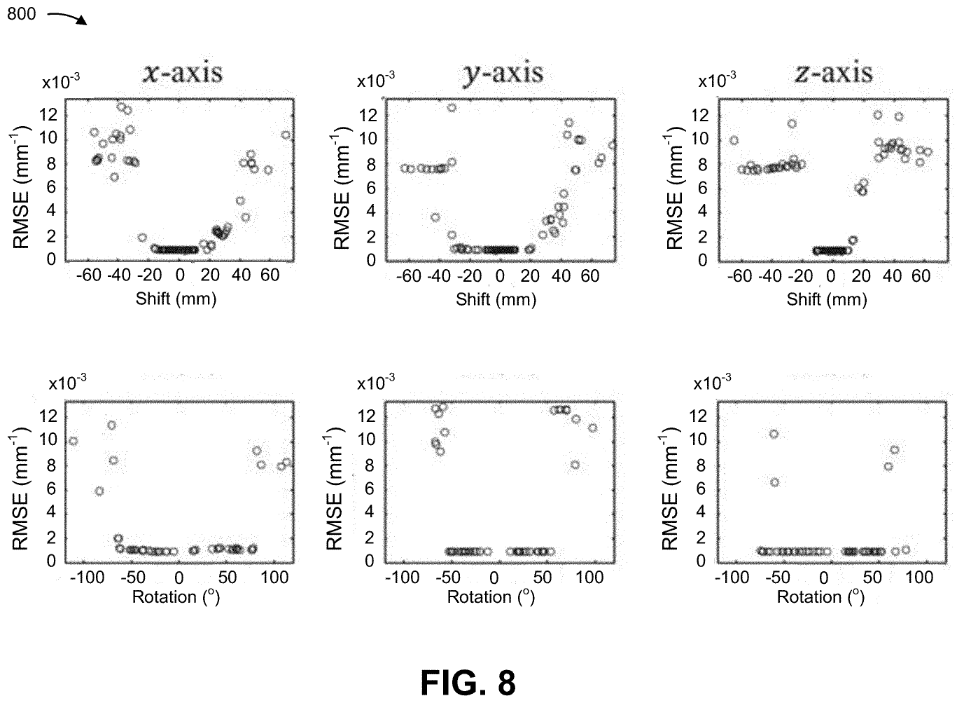

FIG. 8 is a diagram of example graphical views of shift and rotation variations for the reconstruction of difference method. In some implementations, FIG. 8 may depict a performance of a likelihood-based rigid registration of the global RoD method under various random single translations and rotations in three-dimensions. With reference to FIG. 8, the RMSE in reconstruction for ensembles of random translation is shown in a top row, and for ensembles of random rotation in a bottom row. As shown, there may be a well-defined limit beyond which the RMSE rises dramatically. A capture range (e.g., a range for which RMSE differs by <±0.0005 mm⁻¹ of that in preregistered reconstruction) for translations along the x, y, z axes may be [−16 10], [−29 9], and [−11 10] (in mm), respectively. The translation capture ranges may be limited by the prior image being cropped by moving outside the reconstructed volume by the transformation. In some implementations, the translation capture range may be improved by using a large enough reconstruction field of view. In some implementations, a capture range for a single random rotation about any axis may be at least ±50°. Such a broad capture range may be consistent with robust rigid registration and may indicate that the RoD method can handle large errors in initialization in alternating optimization.

In some implementations, for a multivariate registration test, where performance of the RoD method may be tested using ten sets of random λ with nonzero elements, and a mean and standard deviation of the RMSE of 0.02±0.0005 mm⁻¹. In such implementations, the sets may converge to the same results in terms of registration and image quality.

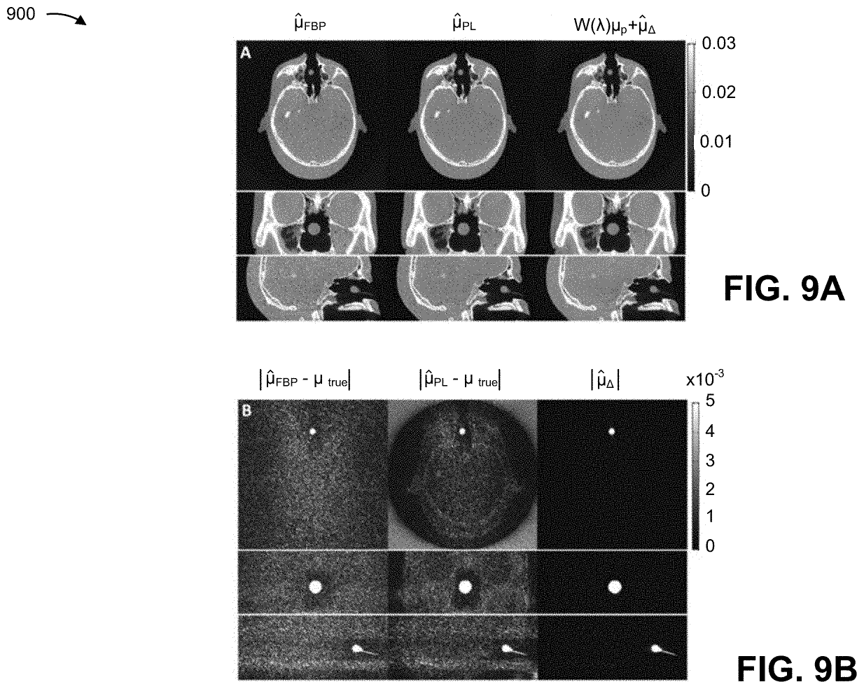

FIGS. 9A and 9B are diagrams of example image views of results that may be generated with systems and/or methods described herein. In some implementations, FIGS. 9A and 9B may depict results of three-dimensional reconstruction of cone-beam CT data in axial, coronal, and sagittal views, where FIG. 9A depicts current anatomy images reconstructed with a filtered back projection (FBP) method, the PL method, and the RoD method, and FIG. 9B depicts absolute values of anatomical change.

In some implementations, reconstructions using the FBP method, the PL method, and the RoD method with an unregistered prior image may be determined and provided in FIG. 9A. Both current anatomy volumes and absolute difference volumes for each method may be determined and provided in FIG. 9B. As shown, the RMSE may be (1.27, 1.57, 1.97)×10⁻³ mm⁻¹ for the RoD method, the PL method, and the FBP method reconstructions, respectively. The difference images for the PL method and the FBP method change images may include high levels of noise in the background. Moreover, the PL method reconstruction may exhibit highly structured noise showing anatomical boundaries (e.g., a boundary between water and bone). In contrast, the RoD method may not include much noise outside the actual change and may yield a more accurate reconstruction of the difference image.

In some implementations, a prior-image-based reconstruction method (e.g., the RoD method) may be utilized to directly estimate change in anatomy in sequential scans. The RoD method may directly reconstruct a difference image by incorporating a prior image into a forward model and by directly regularizing the difference image. The RoD may provide utility and predictability of image roughness and magnitude penalties in regularizing the RoD image. Furthermore, the RoD method may reconstruct the image using local reconstruction methods (e.g., potentially with truncated acquisitions) which may conserve resource utilization and reduce radiation dose.

In some implementations, in joint registration and reconstruction tests, capture ranges of a likelihood-based registration may be largely limited by a range in which the prior image is cropped outside a field of view. The capture range for rotations may be large (±50°) and may indicate a high degree of robustness to errors in registration initialization. In some implementations, the RoD method may offer a valuable approach to estimating anatomical change in clinical sequential imaging scenarios, such as IGS and IGRT, perfusion CT scans, spectral CT, four-dimensional cardiac studies, and/or the like.

In some implementations, penalty coefficients may be selected as scalar values determined through a search. In some implementations, a precalculated space-variant map of penalty coefficients, which adjusts a strength of regularization at different locations of an image volume, may provide additional value.

In some implementations, a likelihood-based rigid registration model may be used, however, a modular (e.g., alternating) design of the RoD method registration and reconstruction may permit any projection-to-volume or potentially a three-dimensional volume-to-volume registration model. For example, some imaging applications (e.g., abdominal imaging) may require use of more challenging non-rigid transformations, and the use of non-rigid registration in the RoD method may be used.

In some implementations, volumetric images of a current anatomy may be formed by adding the RoD estimate to a prior image. Additionally, for efforts that involve quantification and/or localization of anatomical change (e.g., measuring tumor growth/shrinkage, doubling times, changing tumor boundaries for radiotherapy, and/or the like), especially approaches that rely on isolation of change via methods like segmentation, the RoD method images may provide an improvement. The absence of noise and structure due to mismatches between a current image and a prior image may easily confound such quantitation and localization, whereas the RoD method may mitigate such contamination.

As indicated above, FIGS. 4A-9B are provided merely as examples. Other examples are possible and may differ from what was described with regard to FIGS. 4A-9B.

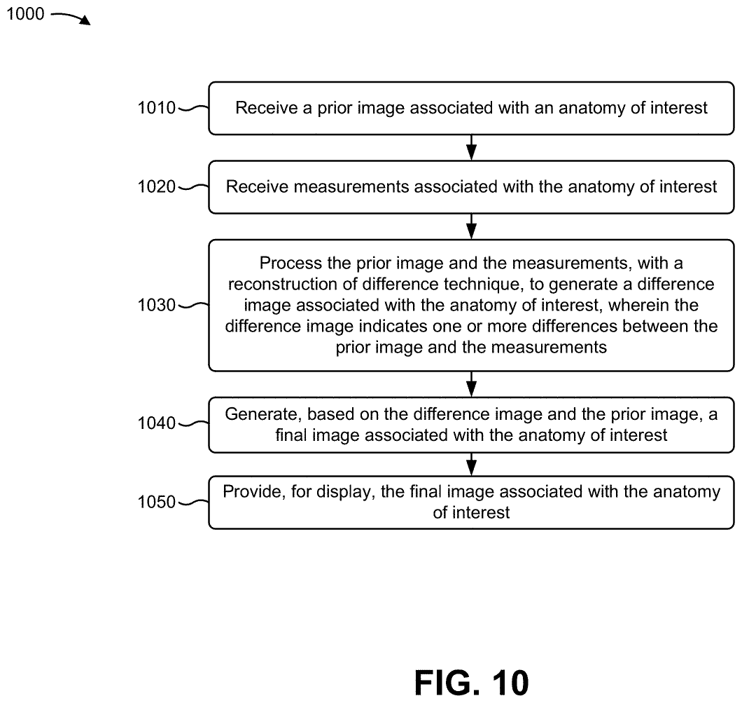

FIG. 10 is a flow chart of an example process 1000 for reconstruction of difference images using prior structural information. In some implementations, one or more process blocks of FIG. 10 may be performed by the control device of FIG. 2. In some implementations, one or more process blocks of FIG. 10 may be performed by another device or a group of devices separate from or including the control device, such as the x-ray source, the collimator, the detector, and/or the motion control system.

As shown in FIG. 10, process 1000 may include receiving a prior image associated with an anatomy of interest (block 1010). For example, the control device (e.g., using processor 320, communication interface 370, and/or the like) may receive a prior image associated with an anatomy of interest, as described above in connection with FIGS. 1-9B.

As further shown in FIG. 10, process 1000 may include receiving measurements associated with the anatomy of interest (block 1020). For example, the control device (e.g., using processor 320, communication interface 370, and/or the like) may receive measurements associated with the anatomy of interest, as described above in connection with FIGS. 1-9B.

As further shown in FIG. 10, process 1000 may include processing the prior image and the measurements, with a reconstruction of difference technique, to generate a difference image associated with the anatomy of interest, wherein the difference image indicates one or more differences between the prior image and the measurements (block 1030). For example, the control device (e.g., using processor 320, storage component 340, and/or the like) may process the prior image and the measurements, with a reconstruction of difference technique, to generate a difference image associated with the anatomy of interest, wherein the difference image indicates one or more differences between the prior image and the measurements, as described above in connection with FIGS. 1-9B.

As further shown in FIG. 10, process 1000 may include generating, based on the difference image and the prior image, a final image associated with the anatomy of interest (block 1040). For example, the control device (e.g., using processor 320, memory 330, and/or the like) may generate, based on the difference image and the prior image, a final image associated with the anatomy of interest, as described above in connection with FIGS. 1-9B.

As further shown in FIG. 10, process 1000 may include providing, for display, the final image associated with the anatomy of interest (block 1050). For example, the control device (e.g., using processor 320, output component 360, communication interface 370, and/or the like) may provide, for display, the final image associated with the anatomy of interest, as described above in connection with FIGS. 1-9B.

Process 1000 may include additional implementations, such as any single implementation or any combination of implementations described below and/or described with regard to any other process described herein.

In some implementations, the control device may provide, for display, the difference image associated with the anatomy of interest. In some implementations, the control device may process the prior image, with a two-dimensional-to-three-dimensional registration, to generate a transformed prior image, and may process the transformed prior image and the measurements, with the reconstruction of difference technique, to generate the difference image associated with the anatomy of interest.

In some implementations, the control device may process the transformed prior image, with the two-dimensional-to-three-dimensional registration, to generate another transformed prior image, and may process the other transformed prior image and the measurements, with the reconstruction of difference technique, to generate the difference image associated with the anatomy of interest.

In some implementations, the control device may integrate the prior image or prior projections in a data consistency term. In some implementations, the control device may utilize the difference image in connection with at least one of cardiac imaging, vascular imaging, angiography, neurovascular imaging, neuro-angiography, image-guided surgery, photon-counting spectral computed tomography, or image-guided radiation therapy. In some implementations, the control device may limit field of view data acquisitions for the measurements associated with the anatomy of interest.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

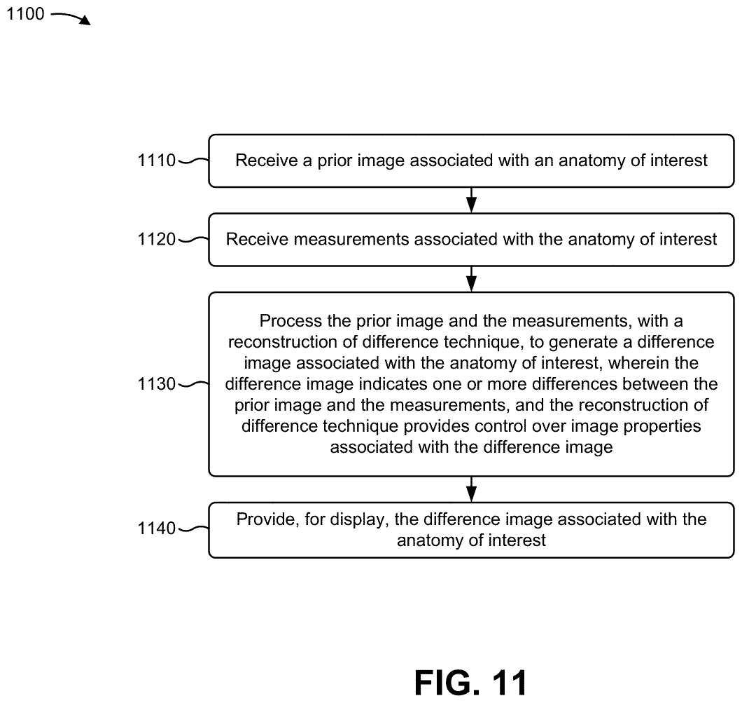

FIG. 11 is a flow chart of an example process 1100 for reconstruction of difference images using prior structural information. In some implementations, one or more process blocks of FIG. 11 may be performed by the control device of FIG. 2. In some implementations, one or more process blocks of FIG. 11 may be performed by another device or a group of devices separate from or including the control device, such as the x-ray source, the collimator, the detector, and/or the motion control system.

As shown in FIG. 11, process 1100 may include receiving a prior image associated with an anatomy of interest (block 1110). For example, the control device (e.g., using processor 320, communication interface 370, and/or the like) may receive a prior image associated with an anatomy of interest, as described above in connection with FIGS. 1-9B.

As further shown in FIG. 11, process 1100 may include receiving measurements associated with the anatomy of interest (block 1120). For example, the control device (e.g., using processor 320, communication interface 370, and/or the like) may receive measurements associated with the anatomy of interest, as described above in connection with FIGS. 1-9B.

As further shown in FIG. 11, process 1100 may include processing the prior image and the measurements, with a reconstruction of difference technique, to generate a difference image associated with the anatomy of interest, wherein the difference image indicates one or more differences between the prior image and the measurements, and the reconstruction of difference technique provides control over image properties associated with the difference image (block 1130). For example, the control device (e.g., using processor 320, storage component 340, and/or the like) may process the prior image and the measurements, with a reconstruction of difference technique, to generate a difference image associated with the anatomy of interest, wherein the difference image indicates one or more differences between the prior image and the measurements, and the reconstruction of difference technique provides control over image properties associated with the difference image, as described above in connection with FIGS. 1-9B.

As further shown in FIG. 11, process 1100 may include providing, for display, the difference image associated with the anatomy of interest (block 1140). For example, the control device (e.g., using processor 320, output component 360, communication interface 370, and/or the like) may provide, for display, the difference image associated with the anatomy of interest, as described above in connection with FIGS. 1-9B.

Process 1100 may include additional implementations, such as any single implementation or any combination of implementations described below and/or described with regard to any other process described herein.

In some implementations, the control device may generate, based on the difference image and the prior image, a final image associated with the anatomy of interest, and may provide, for display, the final image associated with the anatomy of interest. In some implementations, the reconstruction of difference technique may provide local acquisition and reconstruction techniques when the one or more differences are local and spatially limited within the anatomy of interest.

In some implementations, the control device may process the prior image, with a registration, to generate a transformed prior image, and may process the transformed prior image and the measurements, with the reconstruction of difference technique, to generate the difference image associated with the anatomy of interest. In some implementations, the control device may process the transformed prior image, with the two-dimensional-to-three-dimensional registration, to generate another transformed prior image and may process the other transformed prior image and the measurements, with the reconstruction of difference technique, to generate the difference image associated with the anatomy of interest.

In some implementations, the control device may integrate the prior image in a data consistency term to enable the difference image to be generated. In some implementations, the control device may limit field of view data acquisitions for the measurements associated with the anatomy of interest to limit a radiation dose associated with the anatomy of interest.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

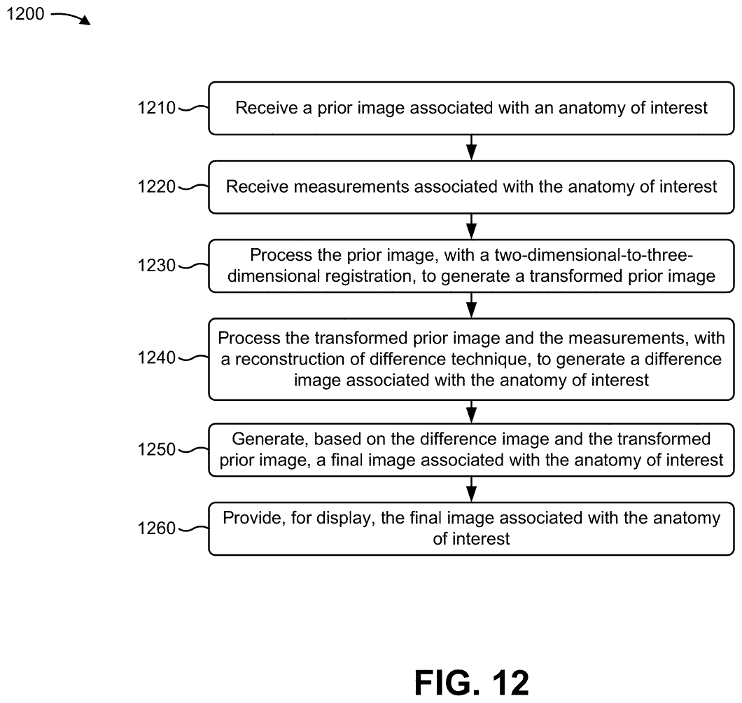

FIG. 12 is a flow chart of an example process 1200 for reconstruction of difference images using prior structural information. In some implementations, one or more process blocks of FIG. 12 may be performed by the control device of FIG. 2. In some implementations, one or more process blocks of FIG. 12 may be performed by another device or a group of devices separate from or including the control device, such as the x-ray source, the collimator, the detector, and/or the motion control system.

As shown in FIG. 12, process 1200 may include receiving a prior image associated with an anatomy of interest (block 1210). For example, the control device (e.g., using processor 320, communication interface 370, and/or the like) may receive a prior image associated with an anatomy of interest, as described above in connection with FIGS. 1-9B.

As further shown in FIG. 12, process 1200 may include receiving measurements associated with the anatomy of interest (block 1220). For example, the control device (e.g., using processor 320, communication interface 370, and/or the like) may receive measurements associated with the anatomy of interest, as described above in connection with FIGS. 1-9B.

As further shown in FIG. 12, process 1200 may include processing the prior image, with a two-dimensional-to-three-dimensional registration, to generate a transformed prior image (block 1230). For example, the control device (e.g., using processor 320, storage component 340, and/or the like) may process the prior image, with a two-dimensional-to-three-dimensional registration, to generate a transformed prior image, as described above in connection with FIGS. 1-9B.

As further shown in FIG. 12, process 1200 may include processing the transformed prior image and the measurements, with a reconstruction of difference technique, to generate a difference image associated with the anatomy of interest (block 1240). For example, the control device (e.g., using processor 320, memory 330, and/or the like) may process the transformed prior image and the measurements, with a reconstruction of difference technique, to generate a difference image associated with the anatomy of interest, as described above in connection with FIGS. 1-9B.

As further shown in FIG. 12, process 1200 may include generating, based on the difference image and the transformed prior image, a final image associated with the anatomy of interest (block 1250). For example, the control device (e.g., using processor 320, memory 330, and/or the like) may generate, based on the difference image and the transformed prior image, a final image associated with the anatomy of interest, as described above in connection with FIGS. 1-9B.

As further shown in FIG. 12, process 1200 may include providing, for display, the final image associated with the anatomy of interest (block 1260). For example, the control device (e.g., using processor 320, output component 360, communication interface 370, and/or the like) may provide, for display, the final image associated with the anatomy of interest, as described above in connection with FIGS. 1-9B.

Process 1200 may include additional implementations, such as any single implementation or any combination of implementations described below and/or described with regard to any other process described herein.

In some implementations, the control device may provide, for display, the difference image associated with the anatomy of interest. In some implementations, the control device may process the transformed prior image, with the two-dimensional-to-three-dimensional registration, to generate another transformed prior image, and may process the other transformed prior image and the measurements, with the reconstruction of difference technique, to generate the difference image associated with the anatomy of interest.

In some implementations, the control device may integrate the prior image in a data consistency term to enable the difference image to be generated. In some implementations, the control device may utilize the difference image in connection with at least one of cardiac imaging, vascular imaging, angiography, neurovascular imaging, neuro-angiography, image-guided surgery, photon-counting spectral computed tomography, or image-guided radiation therapy. In some implementations, the reconstruction of difference technique may provide local acquisition and reconstruction techniques when the one or more differences are local and spatially limited within the anatomy of interest.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

Some implementations, described herein, may provide a system for reconstruction of difference images using prior structural information. For example, the system may receive image data, and receive measurements of an anatomy of interest. The system may process the image data and the measurements of the anatomy of interest using a reconstruction of difference method, and may generate a reconstructed image of the anatomy of interest. The system may integrate the image data in a data consistency term, and may utilize a measurement forward model. The system may apply the reconstruction of difference method to a cardiac function, image-guided surgery, image-guided radiation therapy, and/or the like. The system may limit field of view data acquisitions.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
receive a prior image associated with an anatomy of interest;
receive measurements associated with the anatomy of interest;
process the prior image and the measurements, with a reconstruction of difference technique, to generate a difference image associated with the anatomy of interest,
the difference image indicating one or more differences between the prior image and the measurements;
generate, based on the difference image and the prior image, a final image associated with the anatomy of interest; and
provide, for display, the final image associated with the anatomy of interest.

2. The device of claim 1, wherein the one or more processors are further to:
provide, for display, the difference image associated with the anatomy of interest.

3. The device of claim 1, wherein the one or more processors are further to:
process the prior image, with a two-dimensional-to-three-dimensional registration, to generate a transformed prior image; and
process the transformed prior image and the measurements, with the reconstruction of difference technique, to generate the difference image associated with the anatomy of interest.

4. The device of claim 3, wherein the one or more processors are further to:
process the transformed prior image, with the two-dimensional-to-three-dimensional registration, to generate another transformed prior image; and
process the other transformed prior image and the measurements, with the reconstruction of difference technique, to generate the difference image associated with the anatomy of interest.

5. The device of claim 1, wherein the one or more processors are further to:
integrate the prior image in a data consistency term.

6. The device of claim 1, wherein the one or more processors are further to:
utilize the difference image in connection with at least one of:
cardiac imaging,
vascular imaging,
angiography,
neurovascular imaging,
neuro-angiography,
image-guided surgery,
photon-counting spectral computed tomography, or
image-guided radiation therapy.

7. The device of claim 1, wherein the one or more processors are further to:
limit field of view data acquisitions for the measurements associated with the anatomy of interest.

8. A method, comprising:
receiving, by a device, a prior image associated with an anatomy of interest;
receiving, by the device, measurements associated with the anatomy of interest;
processing, by the device, the prior image and the measurements, with a reconstruction of difference technique, to generate a difference image associated with the anatomy of interest,
the difference image indicating one or more differences between the prior image and the measurements, and
the reconstruction of difference technique providing control over image properties associated with the difference image; and
providing, by the device and for display, the difference image associated with the anatomy of interest.

9. The method of claim 8, further comprising:
generating, based on the difference image and the prior image, a final image associated with the anatomy of interest; and
providing, for display, the final image associated with the anatomy of interest.

10. The method of claim 8, wherein the reconstruction of difference technique provides local acquisition and reconstruction techniques when the one or more differences are local and spatially limited within the anatomy of interest.

11. The method of claim 8, further comprising:
processing the prior image, with a registration, to generate a transformed prior image; and
processing the transformed prior image and the measurements, with the reconstruction of difference technique, to generate the difference image associated with the anatomy of interest.

12. The method of claim 11, further comprising:
processing the transformed prior image, with the two-dimensional-to-three-dimensional registration, to generate another transformed prior image; and
processing the other transformed prior image and the measurements, with the reconstruction of difference technique, to generate the difference image associated with the anatomy of interest.

13. The method of claim 8, further comprising:
integrating the prior image in a data consistency term to enable the difference image to be generated.

14. The method of claim 8, further comprising:
limiting field of view data acquisitions for the measurements associated with the anatomy of interest to limit a radiation dose associated with the anatomy of interest.

15. A non-transitory computer-readable medium storing instructions, the instructions comprising:
one or more instructions that, when executed by one or more processors, cause the one or more processors to:
receive a prior image associated with an anatomy of interest;
receive measurements associated with the anatomy of interest;
process the prior image, with a two-dimensional-to-three-dimensional registration, to generate a transformed prior image;
process the transformed prior image and the measurements, with a reconstruction of difference technique, to generate a difference image associated with the anatomy of interest;
generate, based on the difference image and the transformed prior image, a final image associated with the anatomy of interest; and
provide, for display, the final image associated with the anatomy of interest.

16. The non-transitory computer-readable medium of claim 15, wherein the instructions further comprise:
one or more instructions that, when executed by the one or more processors, cause the one or more processors to:
provide, for display, the difference image associated with the anatomy of interest.

17. The non-transitory computer-readable medium of claim 15, wherein the instructions further comprise:
one or more instructions that, when executed by the one or more processors, cause the one or more processors to:
process the transformed prior image, with the two-dimensional-to-three-dimensional registration, to generate another transformed prior image; and
process the other transformed prior image and the measurements, with the reconstruction of difference technique, to generate the difference image associated with the anatomy of interest.

18. The non-transitory computer-readable medium of claim 15, wherein the instructions further comprise:
one or more instructions that, when executed by the one or more processors, cause the one or more processors to:
integrate the prior image in a data consistency term to enable the difference image to be generated.

19. The non-transitory computer-readable medium of claim 15, wherein the instructions further comprise:
one or more instructions that, when executed by the one or more processors, cause the one or more processors to:
utilize the difference image in connection with at least one of:
cardiac imaging,
vascular imaging,
angiography,
neurovascular imaging,
neuro-angiography,
image-guided surgery,
photon-counting spectral computed tomography, or
image-guided radiation therapy.

20. The non-transitory computer-readable medium of claim 15, wherein the reconstruction of difference technique provides local acquisition and reconstruction techniques when the one or more differences are local and spatially limited within the anatomy of interest.
